(19) United States
(12) Patent Application Publication
(10) Pub. No.: US 2026/0179648 A1
(43) Pub. Date: Jun. 25, 2026

(54) Methods, Systems, and Devices for Pitch-Based Audio Signatures

(71) Applicant: Gracenote, Inc., New York, NY (US)

(72) Inventors: Justin Dan Mathew, Fort Lauderdale, FL (US); Alexander Topchy, New Port Richey, FL (US)

(21) Appl. No.: 19/329,155

(22) Filed: Sep. 15, 2025

Related U.S. Application Data
(60) Provisional application No. 63/736,772, filed on Dec. 20, 2024.

(51) Int. Cl. G10L 25/90

(52) U.S. Cl. CPC G10L 25/90

(57) ABSTRACT

In one aspect, an example computer-implemented method generating a pitch-based audio signature includes: (a) receiving audio content, (b) transforming the audio content, (c) generating a log-spaced frequency domain representation of the transformed audio content, (d) determining one or more magnitudes of the transformed audio content, (e) adjusting the log-spaced frequency domain representation of the transformed audio content based on the determined one or more magnitudes, (f) identifying a plurality of estimated pitch values within the adjusted log-spaced frequency domain representation, wherein identifying the plurality of estimated pitch values comprises identifying a plurality of peak characteristics in the adjusted log-spaced frequency domain representation and ordering the plurality of estimated pitch values based on the plurality of peak characteristics; and (g) generating the pitch-based audio signature based on the identified plurality of estimated pitch values.

### CROSS-REFERENCE TO RELATED APPLICATIONS

This application is a non-provisional of, and claims priority to, U.S. Provisional Pat. App. No. 63/736,772 filed Dec. 20, 2024, which is hereby incorporated by reference herein in its entirety.

### USAGE AND TERMINOLOGY

In this disclosure, unless otherwise specified and/or unless the particular context clearly dictates otherwise, the terms “a” or “an” mean at least one, and the term “the” means the at least one.

In this disclosure, the term “computing system” means a system that includes at least one computing device. In some instances, a computing system can include one or more other computing systems.

### BACKGROUND

In examples, a computing system and/or computing device may be configured to interact with one or more users by identifying audio (e.g., audio content). In examples, this request for identification of the audio may be requested by the user and/or requested computing system and/or computing device (e.g., on a recurring, interval-based request). In some examples, this audio identification may be accomplished by one or more audio fingerprinting protocols to assist in identifying one or more audio recordings. In some examples, one or more audio samples may be recorded by the computing system and/or computing device (e.g., a query fingerprint) which may in turn be compared to one or more reference fingerprints stored in a database, all of which may be aimed at attempting to find a match.

Audio fingerprinting often occurs in noisy, varying environments; thus audio fingerprinting systems are usually designed to overcome to audio content variances and degradations (e.g., encoding artifacts, equalization variations, or noise). However, audio fingerprinting systems typically do so by removing and/or otherwise diminishing one or more characteristics of the audio content (e.g., pitch, timbre, etc.) prior to attempting to match the query fingerprint with one or more reference fingerprints.

### SUMMARY

In another aspect, an example computer-implemented method generating a pitch-based audio signature is disclosed. The computer-implemented method includes: (a) receiving audio content, (b) transforming the audio content, (c) generating a log-spaced frequency domain representation of the transformed audio content, (d) determining one or more magnitudes of the transformed audio content, (e) adjusting the log-spaced frequency domain representation of the transformed audio content based on the determined one or more magnitudes, (f) identifying a plurality of estimated pitch values within the adjusted log-spaced frequency domain representation, wherein identifying the plurality of estimated pitch values comprises identifying a plurality of peak characteristics in the adjusted log-spaced frequency domain representation and ordering the plurality of estimated pitch values based on the plurality of peak characteristics; and (g) generating the pitch-based audio signature based on the identified plurality of estimated pitch values.

In another aspect, an example tangible, non-transitory computer-readable medium is disclosed. The example non-transitory computer-readable medium has stored thereon program instructions that, when executed, cause one or more processors to perform a set of operations comprising: (a) receiving audio content, (b) transforming the audio content, (c) generating a log-spaced frequency domain representation of the transformed audio content, (d) determining one or more magnitudes of the transformed audio content, (e) adjusting the log-spaced frequency domain representation of the transformed audio content based on the determined one or more magnitudes, (f) identifying a plurality of estimated pitch values within the adjusted log-spaced

frequency domain representation, wherein identifying the plurality of estimated pitch values comprises identifying a plurality of peak characteristics in the adjusted log-spaced frequency domain representation and ordering the plurality of estimated pitch values based on the plurality of peak characteristics; and (g) generating the pitch-based audio signature based on the identified plurality of estimated pitch values.

In one aspect, an example metering device is disclosed. The example metering device comprises: (a) one or more processors, (b) one or more microphones, and (c) a tangible, non-transitory computer-readable medium, having stored thereon program instructions that, upon execution by the one or more processors, cause the metering device to perform a set of operations comprising: (a) capturing, via the one or more microphones, audio content, (b) transforming the audio content, (c) generating a log-spaced frequency domain representation of the transformed audio content, (d) determining one or more magnitudes of the transformed audio content, (e) adjusting the log-spaced frequency domain representation of the transformed audio content based on the determined one or more magnitudes, (f) identifying a plurality of estimated

pitch values within the adjusted log-spaced frequency domain representation, wherein identifying the plurality of estimated pitch values comprises identifying a plurality of peak characteristics in the adjusted log-spaced frequency domain representation and ordering the plurality of estimated pitch values based on the plurality of peak characteristics; and (g) generating the pitch-based audio signature based on the identified plurality of estimated pitch values.

### BRIEF DESCRIPTION OF THE DRAWINGS

FIG. 1 is a simplified block diagram of an example computing device.

FIG. 2A illustrates a simplified block diagram of an example audience measurement system.

FIG. 2B illustrates additional example components of the simplified block diagram of the example audience measurement system of FIG. 2A.

FIG. 3 is an example audio content and an example pitch-based audio transformation of the example audio content, according to an example embodiment.

FIG. 4 is a flow chart of an example method.

### DETAILED DESCRIPTION

### I. Overview

A user may watch television, stream movies, listen to music, tune into radio, and/or consume other types of content using one or more media presentation devices. Each media presentation device may output television shows, movies, videos, music, and scheduled advertising, among other media content. In some situations, it may be useful to collect statistics regarding what media content the user is consuming and regarding what the user's response is to media content being emitted by the media presentation devices, perhaps in order to analyze and recommend media content and/or replace various scheduled advertisements with targeted advertisements, among other possible actions.

To facilitate collecting such data across multiple media presentation devices, one or more computing devices (e.g., a metering device) may be used to collect ambient audio including audio emitted by the media presentation devices. In examples, the metering device may be placed at various locations in the user's environment as the user consumes the content from the various media presentation devices. In examples, the computing device may record ambient audio, which may include ambient environment noises, periods of silence, and audio being emitted by one of the media presentation devices.

Based on the collected ambient audio, in examples, the computing device may engage in an audio-identification process to identify the content that the user is consuming, which may include the content being output from one of the various media presentation devices, such as television shows, movies, videos, songs, and/or advertisements, among other examples. The computing device may then use the determined identity of the content as a basis to recommend content, cause the replacement various scheduled advertisements, and/or take other actions corresponding to the identification of the content.

In an effort to identify media content playing in the environment, the computing device may constantly collect and engage in an audio-identification process (e.g., by fingerprinting and analyzing audio content that is associated with the media content). Further, because audio fingerprinting (and subsequent analysis) often occurs in noisy, varying environments, existing audio fingerprinting systems are usually designed to overcome to audio content variances and degradations (e.g., encoding artifacts, equalization variations, or noise)—often by removing and/or otherwise diminishing one or more characteristics of the audio content (e.g., pitch, timbre, etc.). In examples, existing audio fingerprinting systems often remove and/or otherwise suppress these audio characteristics prior to attempting to match the query fingerprint with one or more reference fingerprints.

This complex processing of the audio content prior to fingerprinting and/or engaging in the other steps of the audio-identification process often carries a significant time and computational burden for the metering device and/or the fingerprinting system, among other components. Further, attempting to measure and utilize audio signatures in such varying (and often noisy) environments often leads to degraded query audio and, in turn, degraded matching results. As described herein, in examples, this audio content may include sounds output by a phone, audio associated with a movie being output by a television, and/or music output by a radio, among other examples, which, in contrast, the computing system differentiates from media content containing background noise (e.g., traffic noise, snoring), among other examples. Thus, there exists a need for improved signature generation, particularly in noisy environments.

Provided herein are systems, methods, and devices to generate improved audio signatures using fundamental frequency estimations, including pitch estimation, and then match these pitch-based audio signatures with one or more reference assets stored in a reference database. In a representative method, the computing device may be a metering device monitoring ambient audio in the user's surrounding environment (e.g., a living room with a television streaming a movie) to generate a pitch-based audio signature before engaging in audio-identification processing (e.g., with one or more components of a pitch-based audio signature identification computing system).

To facilitate this, the computing device (e.g., a metering device) may capture, receive, and/or analyze audio from a surrounding environment of the device. For example, the metering device may include one or more microphones through which the computing device may capture audio. In examples, the computing device may periodically or continuously monitor the audio of the surrounding environment of the computing device.

As the computing device captures and/or otherwise receives audio of the environment, the computing device may transform the received audio content to improve the audio-identification process. In some example, the audio content may be captured via one or more microphones of a metering device and then the audio content may be transformed. In some examples, the transformation of this audio content may be pursuant to one or more Fourier transformations (e.g., short-time Fourier transform, fast Fourier transform), a discrete cosine transform, a modified discrete cosine transform, a wavelet transform, or other signal transformation that allows for extraction of frequencies present in the audio content.

In examples, once the computing device has transformed the audio content, the computing device may generate a representation of the transformed audio content. In some examples, such representations may include a log-spaced frequency domain representation of the transformed audio content (e.g., a log-spaced frequency domain grid). In this regard, in examples, the computing device converts the audio content and/or a portion thereof (e.g., a sample) from a time-domain representation to a frequency-domain representation. Once this log-spaced frequency domain representation is generated, it may be adjusted based on one or more characteristics of the audio content and/or the log-spaced frequency domain representation, or both, among other possibilities.

In examples, the computing device may determine one or more characteristics of the transformed the audio content and adjusting one or more representations of the transformed audio content based on these determined characteristics. For example, the computing device may determine the magnitude of the transformed audio content and then adjust one or more representations of the transformed audio content based on the magnitude of the transformed audio content. In some examples, the computing device may adjust a log-spaced frequency domain representation of the transformed audio content based on the determined magnitude of the transformed audio content. In some examples, the computing system transform the audio content based on one or more discrete transformations (e.g., a short-time Fourier transform, a fast Fourier transform, a discrete cosine transform, a modified discrete cosine transform, a wavelet transform) and then adjust a representation of the transformed audio content (e.g., a log-spaced frequency domain representation) based on one or more determined magnitudes of the discretely transformed audio content (e.g., based on a magnitude of a Fourier transformed audio content). In examples, this adjustment to the representation of the audio content may take one or more forms, including: compressing, normalizing, and other signal manipulation functions, some or all of which may be based on the determined magnitude of the transformed audio content. Other examples are possible.

In examples, once the computing device adjusts the representation of the audio content, the computing device may identify a plurality of estimated pitch values within the representation (e.g., an adjusted log-spaced frequency domain representation). To do so, in examples, the computing device may identify a plurality of peak characteristics in the adjusted representation and then perform one or more functions to further analyze the peak characteristics. In some examples, the computing device may order and/or otherwise organize the identified plurality of estimated pitch values based on the plurality of peak characteristics. In some examples, one or more particular sections of the audio content may be buffered and/or samples and then for each buffer and/or sample of audio content (e.g., one second of the audio content), a set of pitch values are estimated and then ordered based on the strength of the pitch candidacy. In example embodiments, the number of pitch values estimated may be defined by a specific numerical value (e.g., twenty estimated pitch values), an upper limit (e.g., a maximum of twenty estimated pitch values), a lower limit (e.g., a minimum of twenty estimated pitch values), and/or some combination thereof, among other numerical values. In examples, pitch candidacy may be evaluated based on characterizing the fundamental frequencies (and the harmonic recurrences of those frequencies) of the query audio content and/or a sample or portion thereof. In examples, this pitch candidacy may be based on one or more characteristics in the adjusted representation of the audio content, including a ranking of peak characteristics (e.g., amplitude, waveform shape), among other possibilities.

To evaluate this candidacy, in examples, the computing device may apply one or more software programs and/or one or more trained machine-learning models. The trained machine-learning model may include one or more weights used to analyze, order, and/or otherwise characterize the estimated pitch values. In examples, the values of the weights may be determined through back-propagation to update initially-set values or updated values such that the machine-learning model may accurately analyze, order, and/or otherwise characterize the estimated pitch values. In example embodiments, a maximum of twenty estimated pitch values may be estimated and then ordered based on pitch candidacy. Other examples are possible.

Based on this ordering, in examples, the computing system may use the ordered set of estimated pitch values to generate a pitch-based sub-fingerprint, which in turn may be used to generate a pitch-based fingerprint, which in turn may be used to generate a pitch-based audio signature. For example, a first pitch-based sub-fingerprint may be generated based on a first sample/buffer of audio content that is one second in length and analyzed to estimate a first set of pitch values, which is then ordered based on the strength of the pitch candidacy. In examples, this first pitch-based sub-fingerprint is representative of the first sample/buffer of audio content (a specific, one-second section of the audio content). In examples, if a plurality of these pitch-based sub fingerprints are generated, each based on a respective sample/buffer of the audio content (each corresponding to a specific, one-second section of the audio content), then the plurality of these pitch-based sub-fingerprints may be combined to form a pitch-based fingerprint (e.g., six pitch-based sub-fingerprints for a single pitch-based fingerprint representing a six-second long section of the audio content). In examples, these pitch-based fingerprints may then be used in connection with other pitch-based fingerprints associated with the audio content and/or a data set that reflects a certain duration of time of the audio content (e.g., a thirty second segment of the audio content) to generate a pitch-based audio signature.

In examples, these pitch-based audio signatures may also contain additional information associated with the audio content that is not pitch-dependent, including a time stamp and/or a source identification (“source ID”), among other possibilities. Furthermore, in examples, these pitch-based audio signatures may be adjusted prior to any further audio-identification processing. For example, a single computing device (e.g., a metering device) may undertake all of the processes described above and then compress the generated audio signature before transmitting to another computing device (e.g., a pitch-based audio signature identification computing system) for further audio-identification processing.

In further examples, the computing device may transmit the pitch-based audio signature (or at least a portion thereof) and an instruction that causes an external computing device to compare the pitch-based audio signature (or at least the portion of thereof) to a set of reference fingerprints (e.g., stored in a reference fingerprint library of a pitch-based audio signature identification computing system). In examples, the computing device may carry out the audio-identification process in an effort to identify media content associated with the audio content. In examples, engaging in the audio-identification process for determining the identity of the received audio may include searching in the received audio for watermarking that encodes an identifier of the media content or using the pitch-based sub-fingerprint/fingerprint/signature data representing the received audio to be compared with reference digital fingerprint data of known audio. In examples, the external computing device may identify a matching reference audio content item based on a reference sub-fingerprint, reference fingerprint, and/or reference signature presenting a threshold similarity with the pitch-based sub-fingerprint/fingerprint/signature data representing the received audio. In response, in examples, the computing device may receive an indication of a particular reference audio content item of a plurality of reference audio content items that matches the portion of the pitch-based audio signature, wherein the indication is based on determining that a particular reference fingerprint of the set of reference fingerprints has at least a threshold extent of similarity with at least one fingerprint of the pitch-based audio signature.

As mentioned above, determining the identity of the received audio may help facilitate content modification, user behavior measurements, and/or other operations of the computing devices and systems described herein. In particular, analyzing audio from a surrounding environment of the device to identify the media content being presented in the surrounding environment of the device may allow for statistics on what media content the user is being presented to the user and how the user reacts to the media content being presented (e.g., if the user continues watching or stops watching a particular media content), among other statistics. A content-presentation device or other computing device may use these statistics to determine what media content to suggest to the user, and which advertisements to use to replace scheduled advertisements, among other examples.

### II. Example Architecture

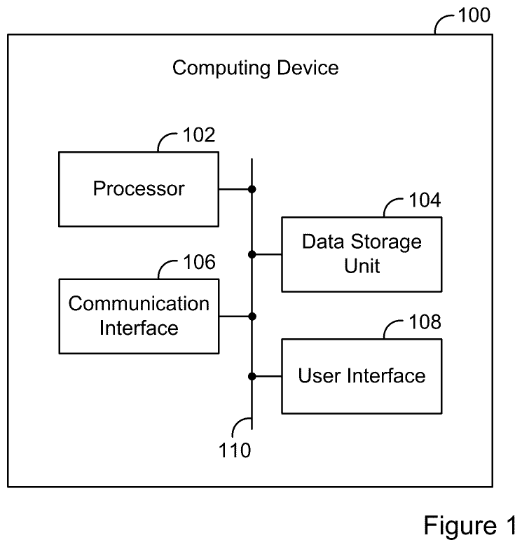

FIG. 1 is a simplified block diagram of an example computing device 100. Computing device 100 can perform various acts and/or functions, such as those described in this disclosure. Computing device 100 can include various components, such as processor 102, data storage unit 104, communication interface 106, and/or user interface 108. These components can be connected to each other (or to another device, system, or other entity) via connection mechanism 110.

Processor 102 can include a general-purpose processor (e.g., a microprocessor) and/or a special-purpose processor (e.g., a digital signal processor (“DSP”)). The processor 102 can execute program instructions included in the data-storage unit 104 as described below.

Data storage unit 104 can include one or more volatile, non-volatile, removable, and/or non-removable storage components, such as magnetic, optical, or flash storage, and/or can be integrated in whole or in part with processor 102. Further, data storage unit 104 can take the form of a non-transitory computer-readable storage medium, having stored thereon program instructions (e.g., compiled or non-compiled program logic and/or machine code) that, when executed by processor 102, cause computing device 100 and/or one or more components of audience measurement system 200 (e.g., metering device 235) to perform one or more acts and/or functions, such as those described in this disclosure. As such, computing device 100 can be configured to perform one or more operations, acts, and/or functions, such as those described in this disclosure. Such program instructions can define and/or be part of a discrete software application. These program instructions can define, and/or be part of, a discrete software application. In some instances, computing device 100 can execute program instructions in response to receiving an input, such as from communication interface 106 and/or user interface 108. Data storage unit 104 can also store other types of data, such as those types described in this disclosure. In some instances, the computing device 100 can execute program instructions in response to receiving an input, such as an input received via the communication interface 106 and/or the user interface 108.

Communication interface 106 can allow computing device 100 to connect to and/or communicate with another other entity according to one or more protocols. In one example, communication interface 106 can be a wired interface, such as an Ethernet interface or a high-definition serial-digital-interface (“HD-SDI”). In another example, communication interface 106 can be a wireless interface, such as a radio, cellular, or WI-FI interface. In this disclosure, a connection can be a direct connection or an indirect connection, the latter being a connection that passes through and/or traverses one or more entities, such as a router, switcher, or other network device. Likewise, in this disclosure, a transmission can be a direct transmission or an indirect transmission. Further, the term “connection mechanism” as used therein refers to one or more mechanisms that facilitate communication between two or more components, devices, systems, or other entities. A connection mechanism can be a relatively simple mechanism, such as a cable or system bus, or a relatively complex mechanism, such as a packet-based communication network (e.g., the Internet). In some instances, a connection mechanism can include a non-tangible medium (e.g., in the case where the connection is wireless)

User interface 108 can facilitate interaction between computing device 100 and a user of computing device 100, if applicable. As such, user interface 108 can include input components such as a keyboard, a keypad, a mouse, a touch-sensitive panel, a microphone, and/or a camera, and/or output components such as a display device (which, for example, can be combined with a touch-sensitive panel), a sound speaker, and/or a haptic feedback system. More generally, user interface 108 can include hardware and/or software components that facilitate interaction between computing device 100 and the user of the computing device 100.

In this disclosure, the term “computing system” means a system that includes at least one computing device, such as computing device 100. As noted above, the computing device 100 and/or components thereof can take the form of a computing system, an example of which could be one or more of the components of audience measurement system 200. In some cases, some or all these entities can take the form of a more specific type of computing system. For instance, the metering device 235 and/or other components of audience measurement system 200 may take the form of a desktop computer, a laptop, a tablet, a mobile phone, a television set, a set-top box, a television set with an integrated set-top box, a media dongle, or a television set with a media dongle connected to it, among other possibilities.

A computing system and/or components thereof can perform various acts, such as those set forth below.

### II. Example Operations

### A. Example Computing Devices and Operational Environments

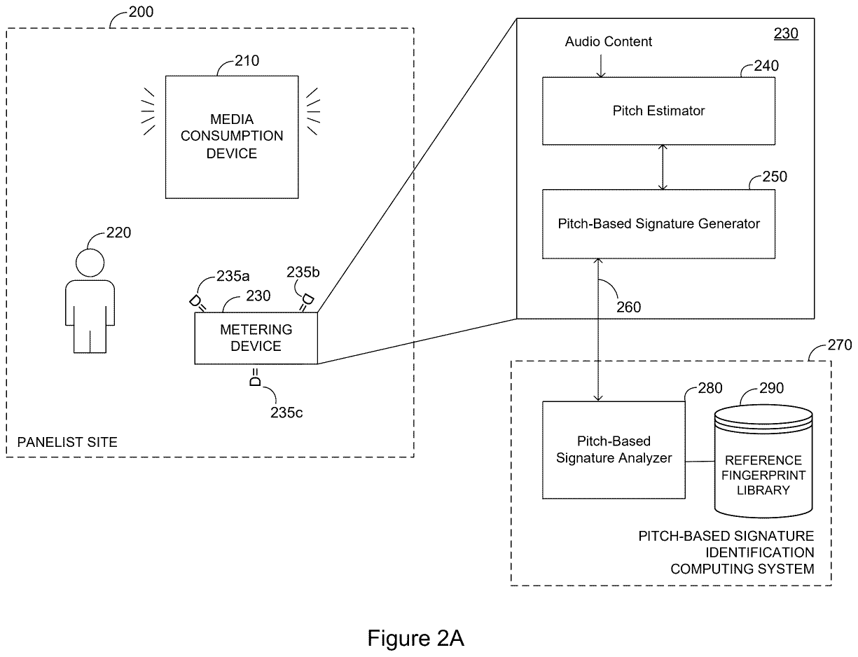

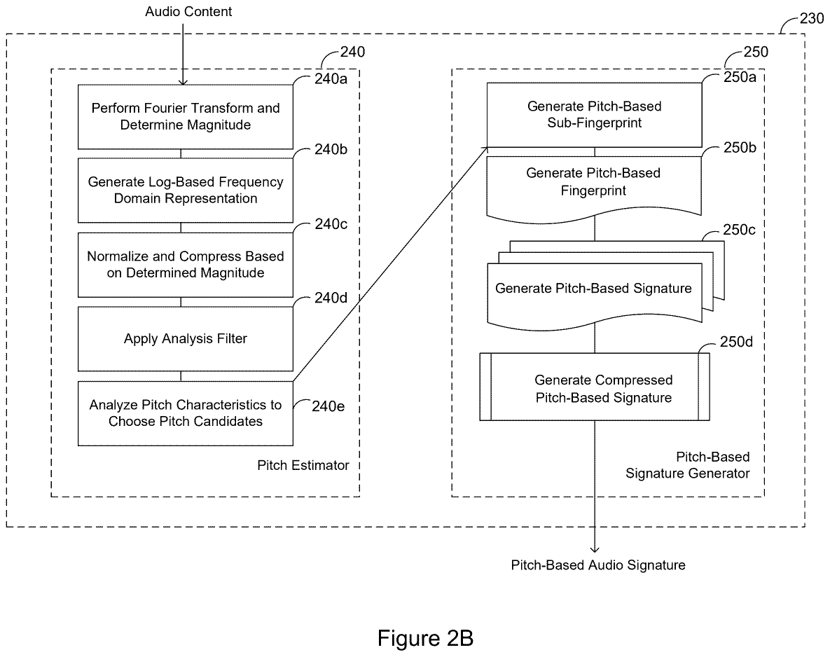

To further illustrate the above-described concepts and others, FIGS. 2A-2B depict example components and devices of an example audience measurement system 200 can be configured to operate in accordance with the techniques described above. The audience measurement system 200 can include one or more computing devices similar to or the same as the computing device 100 depicted in FIG. 1. Further, the example environments and devices depicted in FIGS. 2A-2B are only for illustrative purposes. The features described herein can involve environments, operations, computing devices, components, and functionalities that are configured or formatted differently, include additional or fewer components and/or more or less data, include different types of components and/or data, and relate to one another in different ways.

FIG. 2A illustrates a simplified block diagram of an example audience measurement system 200 in which certain embodiments may be employed. In an example embodiment, the audience measurement system 200 includes a media consumption device 210, an audience member 220, a metering device 230 that includes a pitch estimator 240 and a pitch-based signature generator 250, a pitch-based audio signature identification computing system 270 that includes a pitch-based signature analyzer 280 and a reference fingerprint library 290 (which may contain a plurality of reference pitch-based fingerprints, sub-fingerprints, audio signatures, etc.). In examples, the metering device 230 includes a plurality of microphones. For example, and without loss of generality, as illustrated in FIG. 2A, the plurality of microphones includes three microphones 235a, 235b, and 235c, which will be referenced in the following discussion. However, other embodiments may have two or more microphones, such as 2, 4, 5, 6, 10, 12, or some other number of microphones, for example.

In a further aspect, in examples, the media consumption device 210 streams, broadcasts, and/or otherwise outputs media content such as audio content and/or video content. For example, the media consumption device 210 may provide audio content by itself or as part of video content. The media consumption device 210 may include, for example, a television, radio, or audio content streaming device. The media content may include, for example, a television show, a movie, or music. In examples, the content provided by the media consumption device 210 may be consumed by one or more audience members, such as audience member 220.

The audience member 220 may be one of several audience members (not specifically illustrated in FIGS. 2A or 2B) that consume media content from the media consumption device 210. For example, the audience member 220 may watch a movie or listen to a radio program provided by the media consumption device 210.

In examples, metering device 230 monitors media content provided by the media consumption device 210 (and consumed by the audience member 220) to support identification of the media content by the audience measurement system 200. In some examples, the metering device 230 records the audio content outputted by the media consumption device 210 and undertakes one or more identification protocols (for example, fingerprinting and/or comparative fingerprinting analysis) to assist in identification of the audio content.

To do so, in examples, the metering device 230 includes a plurality of microphones 235a, 235b, and 235c. As illustrated in FIG. 2A, each of the plurality of microphones 235a, 235b, and 235c is associated with a particular orientation in relation to the metering device 230. For example, a first microphone 235a may be positioned to receive audio content originating from the front of the metering device 230, while another microphone 235c may be positioned to receive audio content originating from behind the metering device 230. As another example, as shown in FIG. 2A, the metering device 230 may include two front-facing microphones 235a and 235b that are on opposing ends of the front face of the metering device 230. As another example, the plurality of microphones may be arranged in a circular arrangement. As another example, microphones of the metering device 230 may be in other arrangements and orientations, such as one or more front facing, one or more back facing, one or more side facing, one or more up facing (such as towards the ceiling), one or more down facing (such as towards the floor), one or configured at an angle in relation to a face of the metering device 230, etc. Other examples are possible.

In examples, the metering device 230 is positioned so that at least one of the plurality of microphones 235a, 235b, and 235c is oriented towards the speakers or other audio output of the media consumption device 210. In other examples, metering device 230 is positioned so that two microphones (235a and 235b) of the plurality of microphones are oriented towards the speakers or other audio output of the media consumption device 210, while a third microphone (235c) is located on an opposing surface of the metering device 230. This arrangement may present one or more specific design advantages, including that microphone 230c is able to capture audio content throughout other portions of the environment in which the metering device 230 is operating (for example, from a speaker outputting audio content that may be disposed behind the metering device 230, from audio content that may be reflected off one or more surfaces behind the metering device 230), among other possibilities.

In examples, turning to FIG. 2B, after receiving and/or capturing the audio content in the environment, metering device 230 estimates one or more pitch values in the audio content using pitch estimator 240. In examples, pitch estimator 240 may receive the audio content and then, as illustrated in block 240a, transform the audio content (e.g., using a Fourier transform) and determine one or more characteristics of the audio content (e.g., one or more magnitudes of the audio content). In examples, as illustrated in block 240b, the pitch estimator may also generate a representation of the transformed audio content (e.g., a log-based frequency domain representation). To generate these representations of the audio content, example methods, apparatus, systems and articles of manufacture disclosed herein, may dynamically analyze the audio content (e.g., outputted by the media consumption device) based on real-time characteristics of audio signals. For example, pitch estimator 240 may determine a log-based frequency representation of a sample (e.g., a three second sample) of the audio content and query one or more sources to identify one or more audio content matches based on matching specific audio characteristics of the audio content to one or more pieces of reference audio content and/or representations of the reference audio content (e.g., reference fingerprints and/or reference sub-fingerprints). In examples, the query audio sample of the audio content (e.g., three seconds of audio in the content) may be analyzed and compared against a reference audio database on a regular basis (e.g., every second) to determine potential matches and also to account for changes in the audio content over time (e.g., different portions of the track having different characteristics, transitions in songs, transitions in genres, etc.).

In examples, as illustrated in block 240c, the pitch estimator 240 may adjust the representation based on the determined characteristics of the audio content (e.g., normalize and/or compress the tog-based frequency domain representation based on the determined magnitude).

In examples, as illustrated in block 240d, once the representation is adjusted, the pitch estimator 240 may apply one or more filters before analyzing the peak characteristics of the adjusted representation. In examples, if the pitch estimator 240 determines that resulting pitch-based representation is not satisfactory, the pitch estimator 240 may filter the results to improve one or more characteristics presented in the representation (e.g., decomposition). For example, the pitch estimator may apply one or more analysis filters to the results in order to emphasize particular harmonics based on one or more pitch characteristics presented in the adjusted representation. In other examples, the pitch estimator may filter the results by forcing a single peak/line in the pitch and/or updating other components of the resultant representation. In examples, the pitch estimator may also filter once or may perform an iterative algorithm while updating the pitch characteristics at each iteration, thereby ensuring that the overall convolution of pitch are accounted for in the log-based frequency domain representation of the audio content. In examples, the pitch estimator 240 may determine that the results are unsatisfactory (e.g., based on user and/or manufacturer preferences) and cease the audio-identification process for the particular sample/buffer of the audio content.

In a further example, as illustrated in block 240e, the pitch estimator 240 may identify a plurality of peak characteristics in the adjusted and/or filtered representation and then perform one or more functions to analyze these identified peak characteristics. In some examples, the pitch estimator 240 may estimate a plurality of estimated pitch values based on the plurality of peak characteristics and then order these plurality of estimated pitch values pursuant to one or more protocols. In some examples, the pitch estimator 240 may buffer and/or sample one or more particular sections of the audio content and then, for each buffer and/or sample of audio content generate and order a set of pitch values based on strength of the pitch candidacy. In example embodiments, the number of pitch values estimated may be defined by a specific numerical value (e.g., twenty estimated pitch values), an upper limit (e.g., a maximum of twenty estimated pitch values), a lower limit (e.g., a minimum of twenty estimated pitch values), and/or some combination thereof, among other numerical values. In examples, pitch candidacy may be evaluated based on characterizing the fundamental frequencies (and the harmonic recurrences of those frequencies) of the query audio content and/or a sample or portion thereof. In examples, this pitch candidacy may be based on one or more characteristics in the adjusted representation of the audio content, including a ranking of peak characteristics (e.g., amplitude, waveform shape), among other possibilities.

After generating this ordered set of estimated pitch values, pitch estimator 240 may transmit the some or all of the ordered set of estimated pitch values to pitch-based signature generator 250. In examples, as illustrated in block 250a, pitch-based signature generator 250 may then use the ordered set of estimated pitch values to generate a pitch-based sub-fingerprint. In examples, as illustrated in block 240b, pitch-based signature generator 250 may use one or more pitch-based sub-fingerprints to generate a pitch-based fingerprint.

In examples, as illustrated in block 240c, pitch-based signature generator 250 may use one or more pitch-based fingerprints to generate a pitch-based audio signature. For example, pitch-based signature generator 250 may generate a first pitch-based sub-fingerprint based on a first ordered set of estimated pitch values, which is representative of the first sample/buffer of audio content (a specific, one-second section of the audio content). In examples, pitch-based signature generator 250 may generate a plurality of these pitch-based sub fingerprints (each corresponding to a specific, one-second section of the audio content), and then combine these pitch-based sub-fingerprints to form a pitch-based fingerprint (e.g., six pitch-based sub-fingerprints for a single pitch-based fingerprint representing a six-second long section of the audio content). In examples, pitch-based signature generator 250 may then combine these pitch-based fingerprints with other pitch-based fingerprints associated with the same audio content and data that reflects a certain duration of time of the audio content (e.g., a thirty second segment of the audio content) to generate a pitch-based audio signature. In examples, pitch-based signature generator 250 may generate these pitch-based audio signatures to contain additional information associated with the audio content that is not pitch-dependent, including a time stamp and/or a source identification (“source ID”), among other possibilities.

Furthermore, in examples, these pitch-based audio signatures may be adjusted prior to any further audio-identification processing. In examples, as illustrated in block 240d, pitch-based signature generator 250 may compress the generated audio signature before transmitting to another computing device (e.g., a pitch-based audio signature identification computing system) for further audio-identification processing.

In further examples, the pitch-based signature generator 250 may transmit the pitch-based audio signature (or at least a portion thereof) and an instruction that causes an external computing device (e.g., a pitch-based signature analyzer of a pitch-based audio signature identification computing system) to compare the pitch-based audio signature (or at least the portion of thereof) to a set of reference fingerprints (e.g., stored in a reference fingerprint library of a pitch-based audio signature identification computing system). In examples, the metering device 230 may carry out the audio-identification process in connection with one or more external computing device in an effort to identify media content associated with the audio content.

Turning back to FIG. 2A, pitch-based signature generator 250 may transmit the pitch-based audio signature (or at least a portion thereof) and an instruction that causes pitch-based audio signature identification system 270 to identify media content associated with the audio content. For example, the he pitch-based audio signature (or at least a portion thereof) may be communicated 260 by the metering device 230. As another example, the pitch-based audio signature (or at least a portion thereof) may be communicated by a separate device (not shown), such as one or more components used by the metering device 230 to generate the pitch-based audio signature. The pitch-based audio signature may be communicated 260 by transmitting using a communications interface, such as communications interface 106, for example.

In examples, the pitch-based audio signature identification system 270 includes a pitch-based signature analyzer 280 that processes fingerprints to attempt to identify a piece of media content associated with the pitch-based fingerprints. In example embodiments, the pitch-based audio signature identification system 270 may use also use a reference fingerprint library 290 to attempt to identify a piece of reference media content that is a match for one or more components of the pitch-based audio signature.

In examples, the external computing device may identify a matching reference audio content item based on a reference sub-fingerprint, reference fingerprint, and/or reference signature presenting a threshold similarity with the pitch-based sub-fingerprint/fingerprint/signature data representing the received audio. In response, in examples, the computing device may receive an indication of a particular reference audio content item of a plurality of reference audio content items that matches the portion of the pitch-based audio signature, wherein the indication is based on determining that a particular reference fingerprint of the set of reference fingerprints has at least a threshold extent of similarity with at least one fingerprint of the pitch-based audio signature.

In examples, the pitch-based audio signature identification system 270 receives the set of fingerprints. The pitch-based audio signature identification computing system 270 then attempts to identify the media content associated with the fingerprints using the reference fingerprint library 290. For example, the pitch-based audio signature identification system 270 may utilize the pitch-based signature analyzer 280 to extract one or more pitch-based fingerprints from the compressed pitch-based audio signature and then compare the set of pitch-based fingerprints associated with media content to reference fingerprints stored in the reference fingerprint library 290. Based on the comparison, the pitch-based audio signature identification system 270 can identify one or more reference media files that are within a threshold likelihood of being the media content provided by the media consumption device 210.

To do so, in examples, the pitch-based audio signature identification system 270 may use the pitch-based signature analyzer 280 identify the portion of audio content via a variety of processes, including a comparison of a pitch-based fingerprint of the audio content to reference fingerprints of known media (e.g., pitch-based reference fingerprints for known audio content). For example, t pitch-based audio signature identification system 270 may use pitch-based signature analyzer 280 to generate and/or access query fingerprints for a frame or block of frames of the portion of the audio content outputted by the media consumption device 210 and fingerprinted by the metering device 230, and perform a comparison of the pitch-based query fingerprints to the pitch-based reference fingerprints in order to identify the piece of content or stream of content associated with the media consumption device 210. As described in further detail herein, this identification may be improved by one or more configurations of one or more components of the metering device 230.

For example, if the metering device 230 has a single microphone to capture the audio content outputted by the media consumption device 210, the metering device may not provide optimal audio content recordings and/or associated fingerprints. For example, the orientation of a microphone (for example, microphone 235a) of the metering device 230 used to capture the audio content may result in degraded audio content recordings (for example, a low signal-to-noise ratio for the recorded audio content). These issues with the recorded audio content may, in turn, result in a degraded quality fingerprint and/or sub-fingerprint, which may in turn result in the pitch-based audio signature identification system 270 being unable to identify any reference media files that are within a threshold likelihood of matching with the media content. In example embodiments, metering device 230 may, among other features, evaluate and dynamically update the selection of one or more microphones of the plurality of microphones 235a, 235b, 235c to capture audio content. In examples, this dynamic microphone evaluation and selection may be based on iterative microphone analysis in response to the audio content in the environment in which the metering device 230 is operating, as well as based on the physical characteristics of the environment and/or the location and orientation of the metering device in that environment, any or all of which may change over time. Other examples are possible.

### B. Example Audio Analysis and Pitch-based Feature Representation

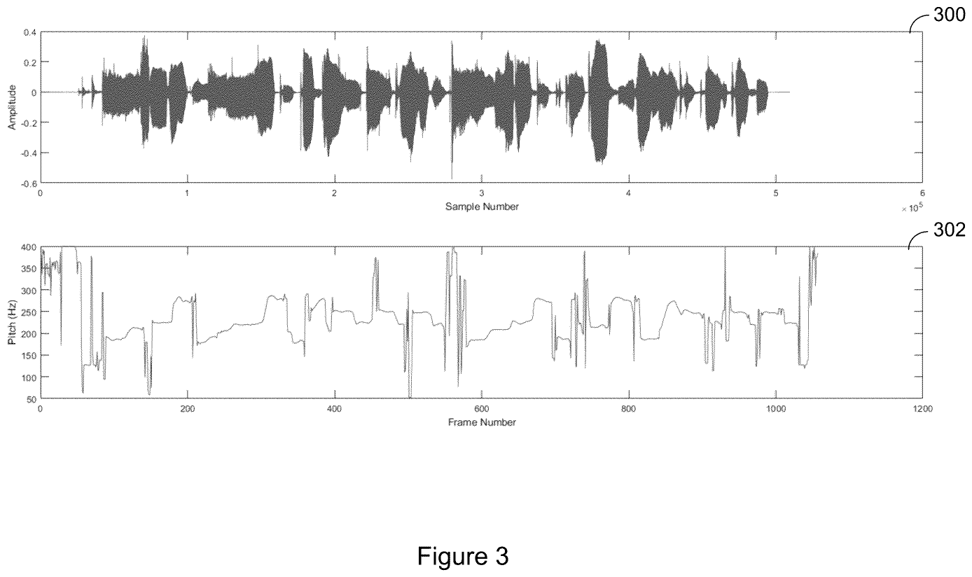

To further illustrate the above-described concepts and others, FIG. 3 depicts an example waveform 300 of an audio content of a media signal and an example pitch-based log-spaced frequency domain representation 302 of the audio content.

As described in conjunction with FIGS. 2A and 2B, when the metering device 230 receives the example audio content (e.g., or samples of the audio content), the pitch estimator 240 transforms the audio content (e.g., using a Fourier transform), determines one or more magnitudes of the transformed audio content (e.g., determines one or more magnitudes of the Fourier transformed audio content) and then generates and adjusts a log-spaced frequency domain representation of the transformed audio content (e.g., based on the determined one or more magnitudes. In examples, further described in conjunction with FIGS. 2A and 2B, the pitch estimator 240 may then use the adjusted log-spaced frequency domain representation of the transformed audio content (shown in example pitch-based log-spaced frequency domain representation 302) to identify and order a plurality of estimated pitch values within the adjusted log-spaced frequency domain representation—including by identifying a plurality of peak characteristics in the adjusted log-spaced frequency domain representation and ordering the plurality of estimated pitch values based on the plurality of peak characteristics.

### C. Example Methods and Aspects

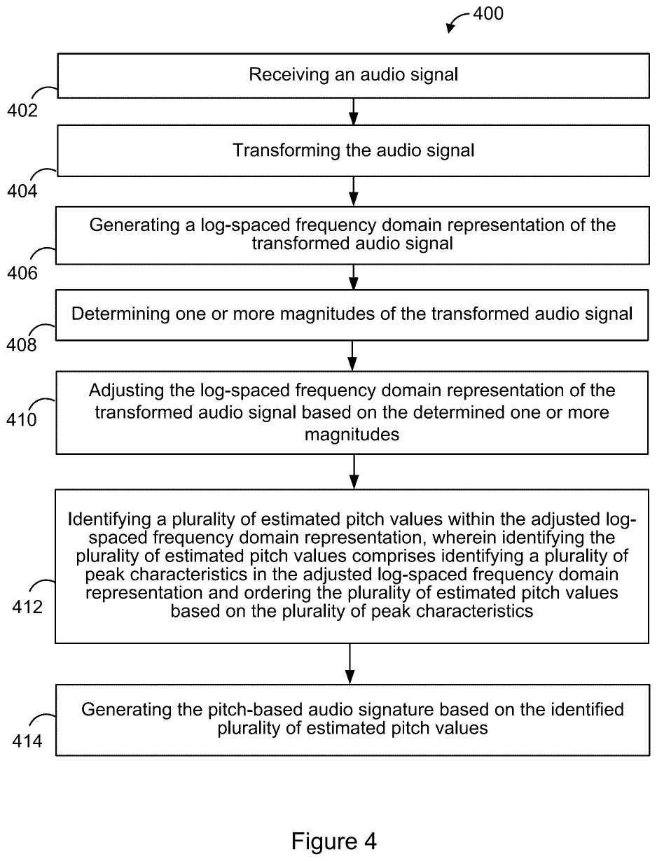

FIG. 4 is a flow chart illustrating an example method 400. The method 400 may be a computer-implemented method, and/or may be carried out by a computing device (e.g., a metering device) and/or one or more components of a media identification system, and/or may be carried out in response to instructions stored on a non-transitory computer-readable medium being executed by a computing device.

At block 402, the method 400 may involve receiving audio content. In some embodiments, receiving the audio content includes capturing, via one or more microphones of a metering device, the audio content. In some embodiments, the audio content may be received from at least one of an Internet-based media stream, a show, a movie, a video, music, and scheduled advertising, among other media content.

At block 404, the method 400 may involve transforming the audio content. In some embodiments, transforming the audio content includes transforming the audio content using a Fourier transform. In some embodiments, the Fourier transform includes a short-time Fourier transform. In some embodiments, the Fourier transform includes a fast Fourier transform.

At block 406, the method 400 may involve generating a log-spaced frequency domain representation of the transformed audio content. In some embodiments, the log-spaced frequency domain representation includes a log-spaced frequency domain grid.

At block 408, the method 400 may involve determining one or more magnitudes of the transformed audio content. In some embodiments, wherein determining one or more magnitudes of the transformed audio content includes determining one or more magnitudes of Fourier transformed audio content. In some embodiments, the Fourier transform includes a short-time Fourier transform. In some embodiments, the Fourier transform includes a fast Fourier transform.

At block 410, the method 400 may involve adjusting the log-spaced frequency domain representation of the transformed audio content based on the determined one or more magnitudes. In some embodiments, adjusting the log-spaced frequency domain representation of the transformed audio content includes normalizing the log-spaced frequency domain representation of the transformed audio content based on the determined one or more magnitudes. In some embodiments, adjusting the log-spaced frequency domain representation of the transformed audio content includes compressing the log-spaced frequency domain representation of the transformed audio content based on the determined one or more magnitudes

At block 412, the method 400 may involve identifying a plurality of estimated pitch values within the adjusted log-spaced frequency domain representation, wherein identifying the plurality of estimated pitch values comprises identifying a plurality of peak characteristics in the adjusted log-spaced frequency domain representation and ordering the plurality of estimated pitch values based on the plurality of peak characteristics. In some embodiments, the plurality of estimated pitch values includes a maximum of twenty estimated pitch values.

At block 414 the method 400 may involve generating the pitch-based audio signature based on the identified plurality of estimated pitch values. In some embodiments, generated pitch-based audio signature corresponds to a particular duration of time of the audio content. In some embodiments, generating the pitch-based audio signature based on the identified plurality of estimated pitch values further includes associating a time stamp and source ID with the generated pitch-based audio signature.

In some embodiments, the method 400 may involve compressing the generated pitch-based audio signature and storing the compressed pitch-based audio signature.

In some embodiments, the method 400 may involve transmitting (i) at least a portion of the pitch-based audio signature and (ii) an instruction that causes a computing device to compare at least the portion of the pitch-based audio signature to a set of reference fingerprints. In some embodiments, the method 400 may involve receiving an indication of a particular reference audio content item of a plurality of reference audio content items that matches the portion of the pitch-based audio signature, wherein the indication is based on determining that a particular reference fingerprint of the set of reference fingerprints has at least a threshold extent of similarity with at least one fingerprint of the pitch-based audio signature.

In line with the disclosure herein, in one aspect, a tangible, non-transitory computer-readable medium storing instructions that, when executed, cause the one or more processors to perform a set of operations that may include: (i) receiving audio content, (ii) transforming the audio content, (iii) generating a log-spaced frequency domain representation of the transformed audio content, (iv) determining one or more magnitudes of the transformed audio content, (v) adjusting the log-spaced frequency domain representation of the transformed audio content based on the determined one or more magnitudes, (vi) identifying a plurality of estimated pitch values within the adjusted log-spaced frequency domain representation, wherein identifying the plurality of estimated pitch values comprises identifying a plurality of peak characteristics in the adjusted log-spaced frequency domain representation and ordering the plurality of estimated pitch values based on the plurality of peak characteristics, and (vii) generating the pitch-based audio signature based on the identified plurality of estimated pitch values.

In line with the disclosure herein, in one aspect, a metering device may include (a) one or more processors, (b) one or more microphones, and (c) a tangible, non-transitory computer-readable medium storing instructions that, when executed, cause the one or more processors to perform a set of operations comprising: (i) capturing, via the one or more microphones, audio content, (ii) transforming the audio content, (iii) generating a log-spaced frequency domain representation of the transformed audio content, (iv) determining one or more magnitudes of the transformed audio content, (v) adjusting the log-spaced frequency domain representation of the transformed audio content based on the determined one or more magnitudes, (vi) identifying a plurality of estimated pitch values within the adjusted log-spaced frequency domain representation, wherein identifying the plurality of estimated pitch values comprises identifying a plurality of peak characteristics in the adjusted log-spaced frequency domain representation and ordering the plurality of estimated pitch values based on the plurality of peak characteristics, and (vii) generating the pitch-based audio signature based on the identified plurality of estimated pitch values.

### III. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects.

1. A computer-implemented method for generating a pitch-based audio signature comprising:
receiving audio content;
transforming the audio content;
generating a log-spaced frequency domain representation of the transformed audio content;
determining one or more magnitudes of the transformed audio content;
adjusting the log-spaced frequency domain representation of the transformed audio content based on the determined one or more magnitudes;
identifying a plurality of estimated pitch values within the adjusted log-spaced frequency domain representation, wherein identifying the plurality of estimated pitch values comprises identifying a plurality of peak characteristics in the adjusted log-spaced frequency domain representation and ordering the plurality of estimated pitch values based on the plurality of peak characteristics; and
generating the pitch-based audio signature based on the identified plurality of estimated pitch values.

2. The computer-implemented method of claim 1, wherein receiving the audio content comprises capturing, via one or more microphones of a metering device, the audio content.

3. The computer-implemented method of claim 1, wherein transforming the audio content comprises transforming the audio content using a Fourier transform, and wherein determining one or more magnitudes of the transformed audio content comprises determining one or more magnitudes of the Fourier transformed audio content.

4. The computer-implemented method of claim 3, wherein the Fourier transform comprises a short-time Fourier transform.

5. The computer-implemented method of claim 3, wherein the Fourier transform comprises a fast Fourier transform.

6. The computer-implemented method of claim 1, wherein the log-spaced frequency domain representation comprises a log-spaced frequency domain grid.

7. The computer-implemented method of claim 1, wherein adjusting the log-spaced frequency domain representation of the transformed audio content comprises normalizing the log-spaced frequency domain representation of the transformed audio content based on the determined one or more magnitudes.

8. The computer-implemented method of claim 1, wherein adjusting the log-spaced frequency domain representation of the transformed audio content comprises compressing the log-spaced frequency domain representation of the transformed audio content based on the determined one or more magnitudes.

9. The computer-implemented method of claim 1, wherein the plurality of estimated pitch values comprises a maximum of twenty estimated pitch values.

10. The computer-implemented method of claim 1, wherein the generated pitch-based audio signature corresponds to a particular duration of time of the audio content.

11. The computer-implemented method of claim 1, wherein generating the pitch-based audio signature based on the identified plurality of estimated pitch values further comprises associating a time stamp and source ID with the generated pitch-based audio signature.

12. The computer-implemented method of claim 11, further comprising compressing the generated pitch-based audio signature and storing the compressed pitch-based audio signature.

13. The computer-implemented method of claim 1, further comprising transmitting (i) at least a portion of the pitch-based audio signature and (ii) an instruction that causes a computing device to compare at least the portion of the pitch-based audio signature to a set of reference fingerprints.

14. The computer-implemented method of claim 13, further comprising receiving an indication of a particular reference audio content item of a plurality of reference audio content items that matches the portion of the pitch-based audio signature, wherein the indication is based on determining that a particular reference fingerprint of the set of reference fingerprints has at least a threshold extent of similarity with at least one fingerprint of the pitch-based audio signature.

15. A tangible, non-transitory computer-readable medium storing instructions that, when executed, cause one or more processors to perform a set of operations comprising:
receiving audio content;
transforming the audio content;
generating a log-spaced frequency domain representation of the transformed audio content;
determining one or more magnitudes of the transformed audio content;
adjusting the log-spaced frequency domain representation of the transformed audio content based on the determined one or more magnitudes;
identifying a plurality of estimated pitch values within the adjusted log-spaced frequency domain representation, wherein identifying the plurality of estimated pitch values comprises identifying a plurality of peak characteristics in the adjusted log-spaced frequency domain representation and ordering the plurality of estimated pitch values based on the plurality of peak characteristics; and
generating a pitch-based audio signature based on the identified plurality of estimated pitch values.

16. The tangible, non-transitory computer-readable medium of claim 15, wherein receiving the audio content comprises capturing, via one or more microphones of a metering device.

17. The tangible, non-transitory computer-readable medium of claim 15, wherein transforming the audio content comprises transforming the audio content using a Fourier transform, and wherein determining the one or more magnitudes of the transformed audio content comprises determining one or more magnitudes of the Fourier transformed audio content.

18. The tangible, non-transitory computer-readable medium of claim 17, wherein the Fourier transform comprises at least one of: (i) a short-time Fourier transform and (ii) a fast Fourier transform.

19. The tangible, non-transitory computer-readable medium of claim 15, wherein the set of operations further comprises:
transmitting (i) at least a portion of the pitch-based audio signature and (ii) an instruction that causes a computing device to compare at least the portion of the pitch-based audio signature to a set of reference fingerprints; and
receiving an indication of a particular reference audio content item of a plurality of reference audio content items that matches the portion of the pitch-based audio signature, wherein the indication is based on determining that a particular reference fingerprint of the set of reference fingerprints has at least a threshold extent of similarity with at least one fingerprint of the pitch-based audio signature.

20. A metering device comprising:
one or more processors;
one or more microphones; and
a tangible, non-transitory computer-readable medium storing instructions that, when executed, cause the one or more processors to perform a set of operations comprising:
capturing, via the one or more microphones, audio content;
transforming the audio content;
generating a log-spaced frequency domain representation of the transformed audio content;
determining one or more magnitudes of the transformed audio content;
adjusting the log-spaced frequency domain representation of the transformed audio content based on the determined one or more magnitudes;
identifying a plurality of estimated pitch values within the adjusted log-spaced frequency domain representation, wherein identifying the plurality of estimated pitch values comprises identifying a plurality of peak characteristics in the adjusted log-spaced frequency domain representation and ordering the plurality of estimated pitch values based on the plurality of peak characteristics; and
generating the pitch-based audio signature based on the identified plurality of estimated pitch values.
